(19) United States
(12) Patent Application Publication
(10) Pub. No.: US 2019/0111664 A1
(43) Pub. Date: Apr. 18, 2019

(54) LAMINATED PANE, METHOD FOR THE PRODUCTION THEREOF, AND USE THEREOF

(71) Applicant: SAINT-GOBAIN GLASS FRANCE, Courbevoie (FR)

(72) Inventors: Marcus NEANDER, ESCHWEILER (DE); Manfred GILLISSEN, HERZOGENRATH (DE); Walter SCHREIBER, AACHEN (DE); Francis SERRUYS, BRUGGE (BE)

(21) Appl. No.: 16/097,231

(22) PCT Filed: Aug. 7, 2017
(86) PCT No.: PCT/EP2017/069892

§ 371 Date: Oct. 26, 2018

(30) Foreign Application Priority Data
Aug. 30, 2016 (EP) 16186282.6

(51) Int. Cl. B32B 17/10; B32B 7/12; B32B 9/00; B32B 27/06; B32B 27/30; B32B 27/40

(52) U.S. Cl. CPC B32B 17/10036; B32B 7/12; B32B 9/002; B32B 17/10302; B32B 17/10761; B32B 17/1077; B32B 2331/04; B32B 27/06; B32B 27/306; B32B 27/40; B32B 2315/08; B32B 2318/04; B32B 2329/06; B32B 17/10788

(57) ABSTRACT

A laminated pane having two main surfaces and a circumferential edge surface is presented. The laminated pane includes, in order and adhesively joined one atop another, a transparent glass pane, a transparent adhesion-promoting layer, an opaque or translucent stone layer, and an all-around seal of the circumferential edge surface. According to one aspect, the all-around seal has at least two polymer layers of different materials. One of the polymer layers is an adhesive film that engages, on its boundary layer, in pores and/or cracks of the stone layer. The other polymer layer is a barrier film that forms a fluid barrier. Methods for producing and using of the laminated pane are also presented.

The invention relates to a laminated pane, a method the production thereof, and use thereof.

Known from the German patent application DE102008052066A1 is an article that includes a pane-shaped composite material having two main surfaces and a circumferential edge surface. The pane-shaped composite material includes, in the order indicated, one atop another and adhesively joined to one another, a first mechanically stable, transparent layer, a first transparent, tear-resistant, adhesion-promoting layer, an opaque or translucent stone layer substantially or completely free volatile compounds, a second transparent, tear-resistant, adhesion-promoting layer, and a second mechanically stable, transparent layer as well as an all-around seal of the circumferential edge surface, which includes a cured casting resin or a tear resistant adhesive film.

The tear-resistant adhesive film is preferably polyvinyl butyral, PVB (polyvinyl butyral), polyethylene vinyl acetate, EVA (ethylene vinyl acetate), polyethylene terephthalate, PET (polyethylene terephthalate), polyvinyl chloride, PVC (polyvinyl chloride), ionomer resins based on ethylene and/or propylene and alpha, beta-unsaturated carboxylic acids or polyurethane, PU (polyurethane), and preferably includes at least one filler. The all-around seal is applied in a separate thermal process step and is colored brownish black by the temperature effect that occurs. Due to this effect, unrestricted use of the laminated pane is not possible.

US 2006/0105121 A1 describes a multipane laminated glass with a bullet-resistant glass function which includes, in the order indicated, one atop another and adhesively joined to one another:
coat layer,
polyurethane layer,
polycarbonate layer,
polyurethane layer,
laminated glass,
polyvinyl butyral or polyurethane layer,
laminated glass,
polyvinyl butyral or polyurethane layer,
offset layer, and
an all-around edge seal that has a polyurethane layer and a polyethylene terephthalate layer.

The object of the present invention is to provide a laminated pane that offers more universal possibilities for use as well as being more simply and thus more economically producible.

The objects of the present invention are accomplished by a laminated pane according to claim 1, a method according to claim 9, and a use according to claim 12. Preferred embodiments emerge from the subclaims.

The laminated pane according to the invention having two main surfaces and a circumferential edge surface includes, in the order indicated, one atop another and adhesively joined to one another,
a transparent glass pane,
a transparent adhesion-promoting layer,
an opaque or translucent stone layer, and
an all-around seal of the circumferential edge surface, which has at least two polymer layers of different materials, wherein one polymer layer of the two polymer layers is an adhesive film that engages on its boundary layer in pores and/or cracks of the stone layer, and the other polymer layer of the two polymer layers is a barrier film that forms a fluid barrier.

With regard to the prior art, it was surprising that the laminated pane that can be produced in a simple manner according to the invention has an optically neutral all-around seal. Moreover, with the use of at least one desirably colored polymer layer, it is possible to provide the all-around seal with a desired coloration. Coloration through the use of at least one colored polymer layer also presents an optically neutral all-around seal since the all-around seal can be adjusted as desired by the user or manufacturer and thus, with its adjustable appearance, blends harmoniously as desired into its surroundings.

The laminated pane according to the invention includes a translucent or opaque stone layer. The laminated pane is preferably also translucent or opaque. Preferably, the stone layer of the laminated pane according to the invention is translucent.

To differentiate with transparency, translucency can be described as permitting passage of light and transparency as permitting passage of an image or a gaze. The reciprocal property of translucency is opacity. If an object has high transparency, it has low opacity, and vice versa.

Besides its two main surfaces and its circumferential edge surface, the pane composite according to the invention can include or be joined to other functional components such as attachment devices, spacers, electrical lines, functional layers, such as protective layers or sound attenuating layers, or glass panes. In addition, it can include recesses and/or drilled holes that can serve to hold and/or to attach functional components.

The laminated pane has a pane-shaped composite material that has, in the order indicated, one atop another and adhesively joined to one another, a transparent glass pane, a transparent adhesion-promoting layer, and an opaque or translucent stone layer, and the circumferential edge surface has the all-around seal. The expression “pane-shaped” means that the main surfaces of the composite material or the laminated pane have a larger surface area than the circumferential edge surface. Preferably, the ratio of the area of one main surface to the area of the circumferential edge surface >1, preferably >2, and, in particular, >3.

The laminated pane is preferably approx. or, within the limits of measuring accuracy, precisely planar. In the present invention, the expression “approx. planar” means that the composite material is bent, in one or a plurality of spatial directions, in the per mill range or by a few percent. The bend must not be so sharp that the stability limit of the stone layer is exceeded and the stone layer breaks or snaps.

The laminated pane can have any outline. Thus, the outline can be angled and/or rounded. Examples of angled shapes are squares, rectangles, rhombuses, triangles, pentagons, hexagons, or stars. Examples of rounded shapes are circles or ellipses. The individual elements of these shapes can also be combined with one another, resulting, for example, in rectangular or circular pane-shaped composite materials whose edge describes a wavy line. The above-described shapes substantially or precisely define the shapes of the laminated panes according to the invention.

In a preferred embodiment, the laminated pane is translucent and is made of or includes
a first mechanically stable transparent glass pane,
a first transparent adhesion-promoting layer,
a translucent stone layer,

which are positioned one atop another and adhesively joined to one another in the order indicated. Here, the expression “mechanically stable” means that the layer is not damaged within wide temperature limits even under the effect of mechanical forces, as are generated, for example, by long-lasting pressure, by brief hard impacts, or by friction, but, instead, retains its integrity and shape.

In the context of the present invention, the expression “transparent” means that the layer in question is image or gaze transmissive. This is especially the case when the layer in question has visible-light transmittance >50%, preferably >70%, and in particular >80%.

The essential component of the laminated pane according to the invention is the all-around seal, which completely covers the circumferential edge surface and and is adhesively joined thereto, has or consists of two polymer layers of different materials. One polymer layer of the two polymer layers is an adhesive film, which, viewed microscopically, engages on its boundary layer in pores and/or cracks of the stone layer; and the other polymer layer of the two polymer layers is a barrier film, which forms a fluid barrier. By this means, the stone layer can, in particular, be at least partially or completely protected against environmental influences; and it is ensured that the all-around seal adheres long-term to the pane-shaped composite material.

A material of the adhesive film is preferably selected from PU (polyurethane) and/or EVA (ethylene vinyl acetate). A material of the barrier film is preferably PET (polyethylene terephthalate). The PU used as the adhesive film is more preferably a TPU (thermoplastic polyurethane).

Preferably, the all-around seal has the same thickness everywhere. The thickness of the all-around seal can vary widely from case to case and thus be optimally adapted to the requirements of the individual case. Preferably, a layer thickness of the barrier film is in the range from 0.05 to 0.20 mm, preferably 0.08 to 0.17 mm, more preferably 0.12 to 0.18 mm. A layer thickness of the adhesive film is preferably in the range from 0.36 to 1.25 mm, more preferably 0.5 to 1.1 mm, even more preferably 0.7 to 0.9 mm.

A width of the all-around seal preferably is or substantially matches the thickness of the pane-shaped composite material, which is formed from the layer thickness of the glass, adhesion-promoter, and stone layers positioned atop one another and adhesively joined to one another. A length of the all-around seal preferably is or substantially matches the circumference of the pane-shaped composite material, which can be calculated in the case of a polygon from the sum of the side lengths or in the case of the circle from a diameter or radius of the circle. The circumferential edge surface is, consequently, preferably completely or substantially completely provided with the all-around seal or completely covered thereby.

Preferably, the barrier film has a coating. Alternatively, or additionally, the barrier film can include a colorant. Furthermore, alternatively, or additionally, the barrier film can have printing. By means of the colorant or the printing, a desired coloring or patterning can be achieved in the laminated pane. The coating is preferably implemented as a barrier coating that forms a fluid barrier, preferably a water barrier. Coating materials to be considered include, for example, silicon dioxide, silicon nitride, and/or titanium oxide. The coating can further protect the laminated pane against environmental influences.

Preferably, the two polymer layers are transparent. In this case, the color and the structure of the stone layer are visible all the way to the edge of the laminated pane.

Preferably, the polymer layers of the all-around seal are tear resistant. Furthermore, at least one of the polymer layers of the all-around seal preferably includes at least one filler. Fillers to be considered include all customary and relatively well-known organic and inorganic fillers per DIN 55943: 1993-11 and DIN EN 971-1:1996-09. The filler content of the all-around seal can vary widely and thus be adapted to the requirements of the individual case. The content is preferably 5 to 50 wt.-%, preferably 7.5 to 45 wt.-%, particularly preferably 10 to 40 wt.-%, and, in particular, 12.5 to 35 wt.-%, based in each case on the total quantity of the all-around seal.

When necessary, the laminated pane preferably has additional layers. Preferably, another transparent adhesion-promoting layer is arranged on the side of the translucent or opaque stone layer facing away from the transparent adhesion-promoting layer; and another transparent glass pane is arranged on the side of the transparent adhesion-promoting layer facing away from the translucent or opaque stone layer. Alternatively, a seal is preferably arranged on the side of the translucent or opaque stone layer facing away from the transparent adhesion-promoting layer, when necessary. In this case, the seal is preferably applied directly on the stone layer. However, an indirect seal via a promoting layer between the stone layer and the seal is also possible. The seal is defined functionally, in particular in terms of its impermeability to moisture.

Preferably, the additional transparent adhesion-promoting layer is tear resistant. The transparent adhesion-promoting layer and the additional transparent adhesion-promoting layer can be the same or different from one another, in other words, they can be constructed from the same materials or from different materials and/or can have different thicknesses. Here again, the thicknesses can vary widely and thus be adapted to the requirements of the individual case. Preferably, the adhesion-promoting layers are in each case 0.4 to 10 mm, preferably 0.5 to 8 mm, particularly preferably 0.6 to 6 mm, and in particular 0.7 to 4 mm thick. When two adhesion promoting layers are used, they preferably have the same thickness.

Preferably, the additional transparent glass pane is mechanically stable. In principle, the transparent glass pane and in the case of a dual structure with two glass panes, the additional transparent glass pane can be the same or different from one another, in other words, they can be constructed from the same materials or from different materials and/or have different thicknesses. The thicknesses can vary widely and thus be adapted to the requirements of the individual case. Preferably, the layers are 2 to 50 mm, more preferably 2 to 40 mm, particularly preferably 2 to 30 mm, and in particular 2 to 25 mm thick.

Furthermore, at least one of the adhesion-promoter layers, glass layers, and/or stone layers of the laminated pane can be made of at least two plies of at least two different materials. Essential for the selection of the materials is the fact that the layer in question has the above-described required property profile. In particular, the at least two plies must be durably adhesively joined to one another and to the adjacent layers.

Materials to be considered for the production of the transparent glass pane and, optionally, of the additional glass pane are, in principle, all materials that have the above-described required property profile. Preferably, the materials are selected from the group consisting of colored and noncolored glasses, colored and noncolored rigid clear plastics that are provided with a barrier layer against vapor diffusion. Preferably selected are, however, colored and noncolored glasses.

Preferably, the colored and noncolored glass is selected from the group consisting of colored and noncolored, non-prestressed, partially prestressed, and prestressed float glass, cast glass, ceramic glass, and glass. Float glass is particularly preferred.

Materials to be considered for the production of the adhesion-promoting layer and, optionally, of the additional adhesion-promoting layer include, in principle, all materials that have the above-described required property profile. Preferably, the material is selected from the group consisting of cast resins cured thermally and/or with actinic radiation and tear-resistant adhesion films. As is known, thermally cured casting resins are produced from thermally curable casting resins that include complementary reactive functional groups that react with one another under the action of thermal energy such that a three-dimensional network is formed in the cured casting resin. Examples of suitable thermally curable casting resins are epoxy resins. As is known, casting resins cured with actinic radiation are produced from casting resins that include reactive functional groups that polymerize anionically, cationically, or radically, in particular radically under the action of actinic radiation. In particular, the reactive functional groups are olefinically unsaturated double bonds. To be considered as actinic radiation are electromagnetic radiation, such as near infrared (NIR), visible light, UV radiation, x-ray radiation, and gamma radiation, or corpuscular radiation, such as electron radiation, proton radiation, beta radiation, or alpha radiation. The casting resins can contain common and known adhesives, as described, for example, in the European patent application EP0799949A1, col. 6, lines 24 to 32. Preferably, the tear-resistant adhesive films are selected from the group consisting of polyvinyl butyral, PVB, poly (ethylene vinylacetate), EVA, polyethylene terephthalate, PET, polyvinyl chloride, PVC, ionomer resins based on ethylene and/or propylene and alpha,beta-unsaturated carboxylic acids or polyurethane, PU. In particular, polyurethane films are used.

Materials to be considered for the production of the translucent or opaque stone layer include, in principle, all types of natural stones and synthetic stones that can be produced in thin layers. The thickness of the stone layer can be varied widely and thus be adapted to the requirements of the individual case. The thickness is, in particular, governed by the desired transparency or opacity, the mechanical stability, and the morphology of the stone. Preferably, the thickness is 1 to 20 mm, preferably 1.5 to 15 mm, and in particular 2 to 10 mm. Examples of particularly well-suited natural stones are granite, gneisses, limestones, crystalline marble, onyx, and semiprecious stones. As already mentioned above, the stone layer can also consist of at least two plies that are adhesively joined to one another. For this, the above-described transparent adhesion-promoting layers can be used. In this embodiment, the laminated pane has two optically different sides, thus offering additional design capabilities within the context of use according to the invention. However, for reasons of simpler producibility and handleability, single-ply stone layers are preferably used. In addition, the stone layer can be composed of different stones, yielding an ornamental or mosaic-like structure in the surface. Preferably, the individual stone parts are adhesively joined to another.

Preferably, the translucent or opaque stone layer is substantially or completely free of volatile compounds. The present invention, the expression “volatile” means that the compound in question already has, at relatively low temperatures, for example, temperatures <150° C., a relatively high vapor pressure, for example, a vapor pressure >10 kPa. At room temperature, the volatile compounds can be liquid, solid, and gaseous inorganic and organic compounds. The volatile compounds can be natural components of the stones, decomposition products of components, and/or residues and/or decomposition products of processing aids that are customarily used in the production of artificial stones or in the cutting, grinding, and polishing of stones. Examples of such volatile compounds are carbon dioxide, hydrogen sulfide, ammonia, carbonates, sulfides, organic and inorganic acids, organic solvents, monomers, or water. Primarily, the volatile compound is water.

In the context of the present invention, the expression “substantially free” means that the translucent or opaque stone layer has such a low volatile compound content that with the use according to the invention of the laminated panes according to the invention, only slight dynamic pressure builds up, which can no longer damage the laminated pane even long-term over many years.

If the volatile compound is water, the water content of the translucent or opaque stone layer is, based on its total amount, preferably <1 wt.-%, more preferably <0.5 wt.-%, and in particular <0.1 wt.-%.

In the context of the present invention, the expression “completely free” means that the volatile compound content of the translucent or opaque stone layer is so low that it is below detection limits.

Due to its structure, the laminated pane has a circumferential edge surface whose contour can vary both from composite material to composite material and with one and the same composite material in subregions of the entire circumference. Thus, the circumferential edge surface can form a 90° angle with each of the two main surfaces, when viewed in cross-section, at least in part of the entire circumference. However, at least in part of the entire circumference, it can be sloped such that it forms, when viewed in cross-section, an angle >90° with one main surface and an angle <90° with the other main surface. However, it can also have a rounded or angular, convex or concave contour, when viewed in cross-section, at least in part of the entire circumference.

Preferably, the circumferential edge surface forms in each case an angle of 90° with the two main surfaces in its entire circumference.

The laminated pane according to the invention can be produced in a manner known per se. However, it is preferably produced using the method according to the invention.

The invention relates to a method for producing a laminated pane described above, wherein

(I) a stone layer is adhesively joined to a transparent glass pane via a transparent adhesion-promoting layer, and

(II) the circumferential edge surface is sealed with an all-around seal, which has at least two polymer layers of different materials.

Preferably, the process steps (I) and (II) are carried out simultaneously, with heat treatment. Thus, production is simplified because in a single process step, lamination and sealing is produced both areally and along the edges of the laminated panes. Moreover, with the suitable selection of the polymer layer system for the edge seal, there exists the advantage that an optically neutral edge is provided in a single process step.

For example, the laminated pane is produced in an autoclave using a temperature process. The process steps (I) and (II) are preferably carried out without pressure.

Preferably, in process step (I), the stone layer is further adhesively joined via another transparent adhesion-promoting layer to another transparent glass pane on the side facing away from the adhesion-promoting layer. Alternatively, in process step (I), the stone layer is preferably further sealed by means of a on the side facing away from the adhesion promoting layer.

For the method according to the invention, first, a translucent or opaque stone layer is prepared in the desired thickness in a customary and known manner, for example, using the method known from the American patent U.S. Pat. No. 4,177,789. Preferably, for further processing, the translucent stone layer is joined to a temporary carrier, from which it can be readily detached again.

Prior to carrying out the first process step of the method according to the invention, the translucent or opaque stone layer can still be ground, polished, and/or freed of adhering contaminants, in particular processing aids.

Within the context of pretreatment for the method according to the invention, the translucent or opaque stone layer can be freed substantially or completely of the above-described volatile compounds. This can be done using chemical and/or physical methods, in particular physical methods. The conditions selected are governed especially by the volatile compound content of the translucent or opaque stone layer as well as the material composition and the morphology of the volatile compounds.

Preferably, for this, the translucent or opaque stone layer is heated in a dry atmosphere or in a vacuum, preferably in a dry atmosphere. The thermal energy can be supplied by gaseous media, preferably the dry atmosphere itself, heating plates, heating rollers, or radiant heaters. Preferably, the translucent or opaque stone layer is heated long enough to reach the desired maximum material temperature >100° C. Preferably, it should not exceed 200° C., more preferably 180° C., and in particular 160° C.

The heating of the translucent or opaque stone layer can be done by heating it quickly with the above-described heat sources that have the maximum material temperature. However, preferably, the translucent or opaque stone layer is heated gradually over a relatively long period of time, for example, by a ramped or stepped increasing of the temperature. It is essential here for the heating time to be adjusted such that no thermal stresses develop in the translucent or opaque stone layer.

After the desired maximum temperature is reached, the translucent or opaque stone layer is held at this temperature for a relatively long time, preferably for 30 minutes to 24 hours, more preferably 1 to 12 hours, and, in particular, 2 to 6 hours.

Then, the translucent or opaque stone layer is cooled. Here again, it is essential for the cooling time to be adjusted such that no thermal stresses develop in the translucent or opaque stone layer. Preferably, the translucent or opaque stone layer is cooled gradually, preferably by ramped or stepped reduction of its temperature. Preferably used as a cooling means is a dry gaseous medium, whose temperature is reduced suitably. Here and in the subsequent process steps, care must be taken, for example, by working in a dried, clean atmosphere, that the translucent or opaque stone layer freed of of volatile compounds does not again absorb volatile compounds, in particular water.

In the process step (I) of the method according to the invention, the translucent or opaque stone layer is adhesively joined on one or both sides via one of the above-described adhesion-promoting layers to, in each case, one of the above-described glass panes. If the adhesion-promoting layers are produced from a casting resin curable thermally and/or with actinic radiation, the casting resin can be applied in the form of a bead on one end of a glass pane over its width. Then, the glass pane is placed with this region on the stone layer, after which it clings to the surface of the stone layer, wherein it is displaced due to its own weight, degassing the casting resin in front of it. However, the casting resin can also be applied in the central region of the stone layer, after which a convexly curved, mechanically stable, transparent layer is placed on the casting resin and then relaxed such that the casting resin is uniformly distributed on the stone layer by the layer placed thereon. Following this, the resultant casting resin layer is cured thermally and/or with actinic radiation. Then, optionally, the pane-shaped laminate of the stone layer, the adhesion-promoting layer, and the glass pane is rotated to the other side, and, if necessary, the free side of the stone layer can be provided with additional adhesion-promoting layer and glass panes in the same manner as described above or with a seal.

If the adhesion-promoting layers are made of the above-described adhesive films, all layers of the laminated glass pane are placed one atop another in a precisely fitting manner. Then, the air between the layers is removed in a suitable device, for example, in a vacuum bag, by applying a vacuum, wherein the external air pressure of 100 kPa presses the layers together. Preferably, the step is carried out at a temperature of >50° C. Then, the resultant composite material can still be post-treated at temperatures up to 150° C. at a uniformly acting pressure >100 kPa, for example, in an autoclave. The layers positioned one atop another can, however, also be prelaminated at a temperature >50° C., for example, 70° C., and a pressure>100 kPa, for example, 700 kPa, after which the layers of the resultant prelaminate are adhesively joined to one another at a uniformly acting pressure >100 kPa, for example, 1,200 kPa, and at a temperature >100° C., for example, 135° C., in an autoclave.

Preferably, the adhesion-promoting layers are produced from tear-resistant, transparent adhesive films.

The circumferential edge surface of the resultant pane-shaped composite material is provided, in process step (II), with the all-around seal. The all-around seal is produced from the above-described materials. Preferably, the polymer layers are produced in the desired thicknesses. The polymer layers are adhesively joined to the edge surface either individually or together in the form of a strip of a width that corresponds at least to the width of the circumferential edge surface.

Preferably, these polymer layers are laminated together with the glass pane and the stone layer in a common process step. Optionally, excess material of the all-around seal that protrudes beyond the level of one or both of the main surfaces can subsequently be removed.

The laminated pane according to the invention, in particular the laminated pane produced using the above-described method according to the invention, has special advantages and can, consequently, be used in a variety of ways. It can be used particularly well in the context of use according to the invention as a novel purely decorative and/or decorative architectural object and/or as a novel purely decorative and/or decorative architectural component indoors and outdoors. Or alternatively, it can be used for the production of such a new object for such a new component. When, in the laminated pane, the stone layer is exposed, the laminated pane is preferably suitable for an interior application. When the stone layer is covered on both sides, the laminated pane is suitable for interior and exterior applications.

The term “decorative-architectural” means that the object or the component satisfies a structural or functional property in or on a section of a building in addition to a decorative effect.

Examples of such novel objects and novel components are purely decorative or decorative-architectural components for indoors and outdoors, in particular indoor or outdoor linings of structures such as exterior façades or interior walls. However, the laminated pane according to the invention or the laminated pane produced by the method according to the invention can also be used as cladding for door leaves, covering for lights, loadbearing furniture components such as tabletops or work surfaces, for example, in kitchens, components for covering roofs or privacy screens for railings.

In the following, exemplary embodiments of the laminated pane according to the invention are explained by way of example with reference to the accompanying figures.

The schematic representations are not true to scale. Consequently, the size ratios depicted do not correspond to the size ratios used in the working of the invention in practice. They depict:

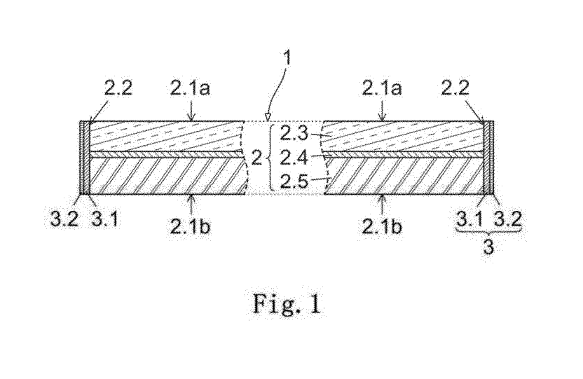

FIG. 1 a schematic cross-sectional view of a laminated pane according to the invention in accordance with a first embodiment;

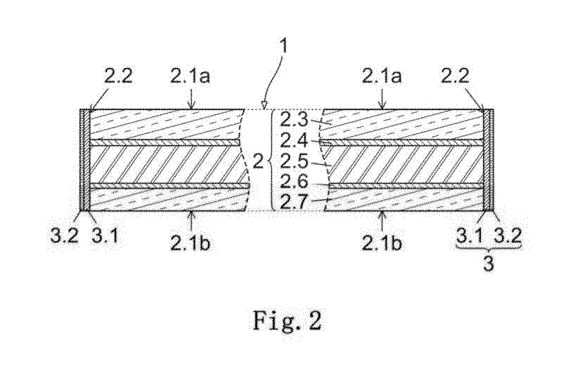

FIG. 2 a schematic cross-sectional view of a laminated pane according to the invention in accordance with a second embodiment;

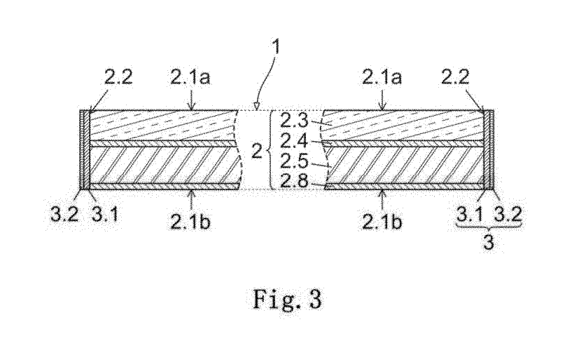

FIG. 3 a schematic cross-sectional view of a laminated pane according to the invention in accordance with a third embodiment; and

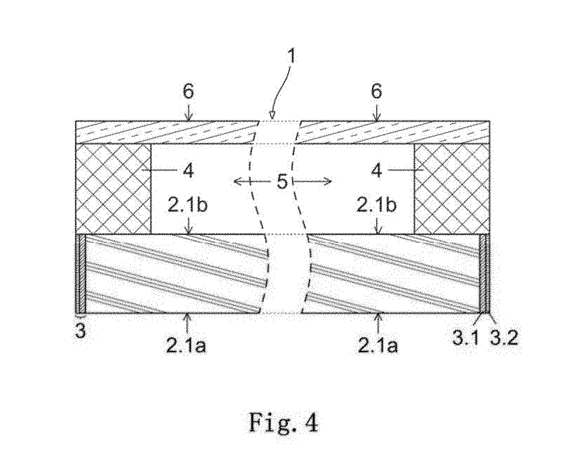

FIG. 4 a schematic cross-sectional view of a laminated pane according to the invention in the form of a multiple insulating glass that includes a laminated pane in accordance with FIGS. 1 to 3.

FIG. 1 depicts a schematic cross-sectional view of a laminated pane according to the invention in accordance with a first embodiment.

A first embodiment in accordance with FIG. 1 of the laminated pane 1 according to the invention, which is preferred but does not restrict the invention, is, for example, a decorative translucent lining for an interior wall.

The laminated pane 1 comprises a pane-shaped composite material 2 having two main surfaces 2.1a and 2.1b and a circumferential edge surface 2.2 forming the edge of the laminated pane 1, which is covered by an all-around seal 3. Optionally, the laminated pane 1 also includes mounting brackets, with which it can be arranged on the interior wall. For the sake of clarity, the mounting brackets are not shown.

The composite material 2 includes, one atop another and adhesively joined to one another in the order indicated, a transparent glass pane 2.3, a transparent adhesion-promoting layer 2.4, and a translucent or opaque stone layer 2.5. The all-around seal 3 of the circumferential edge surface 2.2 has one polymer layer 3.1 in the form of an adhesive film and another polymer layer 3.2 in the form of barrier film forming a fluid barrier.

The transparent glass pane 2.3 is a transparent glass pane having the dimensions 300 mm×300 mm, a thickness of 4 mm, and visible-light transmittance of 90%. The outer surface of the transparent glass pane 2.3 forms the main surface 2.1a, whereas the outer surface of the translucent or opaque stone layer 2.5 forms the other main surface 2.1b.

The translucent or opaque stone layer 2.5 is, in this embodiment, a 5-mm-thick translucent marble sheet, which has the same dimensions as the transparent glass pane 2.3. The translucent stone layer 2.5 is completely free of volatile compounds. In particular, it is free of water. It is joined to the transparent glass pane 2.3 via the transparent adhesion-promoting layer 2.4. The transparent adhesion-promoting layer 2.4 is a 0.8-mm-thick adhesive film made of polyurethane with the same dimensions as the translucent stone layer 2.5 and the transparent glass pane 2.3.

The pane-shaped, translucent composite material 2 of the laminated pane 1 is thus 9.8 mm thick in all, precisely matching the width of the circumferential edge surface 2.2. Its length is 1200 mm and its total area is 0.01176 m². The ratio of the area of one main surface 2.1a or 2.1b to the area of the circumferential edge surface 2.2 is, consequently, approx. 8:1. Viewed in cross-section, the circumferential edge surface 2.2 forms, in each case, an angle of 90° with the two surfaces 2.1a and 2.1b.

The circumferential edge surface 2.2 is covered with the all-around seal 3, which is formed by a 0.8-mm-thick strip of a polymer layer 3.1 made of EVA and joined to the circumferential edge surface 2.2 and another polymer layer 3.2 made of PET and arranged on the side of the polymer layer 3.1 facing away from the edge surface 2.2.

The laminated pane 1 is produced by first subjecting the translucent stone layer 2.5 to a pretreatment. The translucent stone layer 2.5 of the dimensions 300 mm×300 mm×5 mm is polished on its surface. Then, solid residues resulting from the polishing that may be present are removed by compressed air. After that, the translucent stone layer 2.5 is rinsed with deionized water and pre-dried. In a forced-air oven that is operated with purified and dried air, at a maximum material temperature of 140° C., the pre-dried, translucent stone layer 2.5 is freed of volatile compounds, in particular of water. Then, the translucent stone layer 2.5, free of volatile compounds, is gradually cooled to room temperature.

After that, in the order indicated, the polished, cleaned, and dried transparent glass pane 2.3 of the dimensions 300 mm×300 mm×4 mm, the transparent adhesion-promoting layer 2.4 of the dimensions 300 mm×300 mm×0.8 mm, and the translucent stone layer 2.5 free of volatile compounds are placed one atop another in a precisely fitting manner.

Subsequently, the circumferential edge surface 2.2 of the resultant, pane-shaped, translucent composite material 2 is joined with a strip with a width of 9.8 mm made of the polymer layer 3.1 made of EVA and of the other polymer layer 3.2 made of PET such that the circumferential edge surface 2.2 is completely covered by the all-around seal 3. The glass pane layered with the stone layer and the edge-sealed polymer layers 3.1, 3.2 are adhesively joined to one another using a heat-pressure treatment at 100° C. in an autoclave. In a single working step, the layers are laminated and their edges are simultaneously sealed.

The laminated pane 1 has high mechanical stability and excellent interlayer adhesion. It is, consequently, very suitable as an interior wall cladding.

FIG. 2 depicts a schematic cross-sectional view of a laminated glass pane according to the invention in accordance with a second embodiment. The laminated pane 1 depicted in FIG. 2 corresponds to the laminated pane 1 depicted in FIG. 1, with the difference that on the side of the translucent stone layer 2.5 facing away from the transparent adhesion-promoting layer 2.4, another transparent adhesion-promoting layer 2.6 is arranged and on the side of the adhesion-promoting layer 2.4 facing away from the stone layer 2.5, another transparent glass pane 2.7 is arranged such that an outer surface of the transparent glass pane 2.7 instead of the outer surface of the translucent stone layer 2.5 forms the main surface 2.1b.

The other transparent glass pane 2.7 is another transparent glass pane having the dimensions 300 mm×300 mm, a thickness of 4 mm, and visible-light transmittance of 90%.

The other transparent adhesion-promoting layer 2.6 is a 0.8-mm-thick adhesive film made of polyurethane with the same dimensions as the translucent stone layer 2.5, the transparent adhesion-promoting layer 2.4, and the transparent glass panes 2.3 and 2.7.

The pane-shaped, translucent composite material 2 of the laminated pane 1 is thus 14.6 mm thick in all, precisely the width of the circumferential edge surface 2.2. Its length is 1200 mm and its total area is 0.01752 m². The ratio of the area of one main surface 2.1a or 2.1b to the area of the circumferential edge surface 2.2 is, consequently, approx. 5:1. Viewed in cross-section, the circumferential edge surface 2.2 forms an angle of 90°, in each case, with the two main surfaces 2.1a and 2.1b.

The circumferential edge surface 2.2 is, corresponding to the first embodiment, covered with the all-around seal 3, which is formed by a 0.8-mm-thick strip made of a polymer layer 3.1 made of EVA joined with the circumferential edge surface 2.2 and another polymer layer 3.2 made of PET arranged on the side of the polymer layer 3.1 facing away from the edge surface 2.2.

The laminated pane 1 is produced in the same manner as the laminated pane depicted in FIG. 1, with the difference that, on the free side of the translucent stone layer 2.5, the other transparent adhesion-promoting layer 2.6 of the dimensions 300 mm×300 mm×0.8 mm, and the other transparent glass pane 2.7 of the dimensions 300 mm×300 mm×3 mm are placed one atop another in a precisely fitting manner in the order indicated. The circumferential edge surface 2.2 of the resultant, pane-shaped, translucent composite material 2 is provided with a strip of the dimensions 4 m×12.6 mm×1 mm made of the polymer layer 3.1 made of EVA and the other polymer layer 3.2 made of PET such that the circumferential edge surface 2.2 is completely covered by the all-around seal 3. The layers are also adhesively joined to one another using the heat-pressure treatment at 100° C. in the autoclave.

The laminated pane 1 depicted in FIG. 2 is likewise of excellent mechanical stability and the statements made concerning the laminated pane depicted in FIG. 1 apply accordingly.

FIG. 3 depicts a schematic cross-sectional view of a laminated pane according to the invention in accordance with a third embodiment. The laminated pane 1 depicted in FIG. 2 corresponds to the laminated pane 1 depicted in FIG. 1, with the difference that a seal 2.8 is arranged on the side of the translucent stone layer 2.5 facing away from the transparent adhesion-promoting layer 2.4 such that an outer surface of the seal 2.8 instead of the outer surface of the translucent stone layer 2.5 forms the main surface 2.1b. The laminated pane 1 is produced according to a method that corresponds to the method for producing the laminated pane depicted in FIG. 1, with the difference that the seal 2.8 is placed in a precisely fitting manner on the side of the stone layer 2.5 facing away from the transparent adhesion-promoting layer 2.4 and, then, the circumferential edge surface is provided with the all-around seal. Alternatively, the seal can also be applied later to the outer surface of the stone layer 2.5 in the form of a lacquer or a resin. In this embodiment, the laminated pane is outstandingly suitable as an external façade cladding, since the seal protects against contamination and mechanical, chemical, and thermal damage.

FIG. 4 depicts, as another embodiment that is preferred but does not restrict the invention, a schematic cross-sectional view of a laminated pane 1 in the form of a multiple insulating glass that includes a laminated pane in accordance with one of the preceding embodiments described in FIG. 1 to 3. This laminated pane 1 combines a laminated pane 1 described in FIG. 1, 2, or 3 via a spacer 4 made of aluminum, as is customarily used for the production of multipane insulating glazings per DIN EN 1279-2, using a primary and a secondary adhesive (not shown) adhesively with a 3-mm-thick prestressed glass pane 6 of the dimensions 300 mm×300 mm, such that an insulating cavity 5 results between the laminated pane 1 and the glass pane 6. In FIG. 4, for the sake of clarity, the individual layers of the composite material 2 of the laminated pane 1 are no longer depicted. In this configuration, the laminated pane 1 is outstandingly suitable for outdoor applications, since the prestressed glass pane 6 protects the laminated pane 1 against contamination and mechanical, chemical, and thermal damage. In addition, thermal insulation is implemented such that with the use of the laminated pane for building construction, an insulating effect is realized.

### LIST OF REFERENCE CHARACTERS:

1 laminated pane,

2 composite material

2.1a first main surface,

2.1b second main surface,

2.2 circumferential edge surface,

2.3 glass pane,

2.4 adhesion-promoting layer,

2.5 stone layer,

2.6 another adhesion-promoting layer,

2.7 another glass pane,

2.8 seal

3 all-around seal

3.1 polymer layer

3.2 another polymer layer

4 spacer

5 insulating cavity

6 glass pane

1.-13. (canceled)

14. A laminated pane having two main surfaces and a circumferential edge surface, the laminated pane comprising, in order and adhesively joined one atop another:
a transparent glass pane;
a transparent adhesion-promoting layer;
an opaque or translucent stone layer; and
an all-around seal of the circumferential edge surface,
wherein the all-around seal comprises at least two polymer layers of different materials,
wherein one polymer layer of the at least two polymer layers is an adhesive film that engages, on its boundary layer, in pores and/or cracks of the stone layer, and
wherein the other polymer layer of the at least two polymer layers is a barrier film that forms a fluid barrier.

15. The laminated pane according to claim 14,
wherein a material of the adhesive film is selected from at least one of:
a) polyurethane (PU), and b) EVA, and
wherein a material of the barrier film is PET.

16. The laminated pane according to claim 15, wherein the PU is a thermoplastic.

17. The laminated pane according to claim 14,
wherein a layer thickness of the barrier film is in a range from 0.05 mm to 0.20 mm, and
wherein a layer thickness of the adhesive film is in a range from 0.36 mm to 1.25 mm.

18. The laminated pane according to claim 17, wherein a layer thickness of the barrier film is in the range from 0.12 mm to 0.18 mm.

19. The laminated pane according to claim 17, wherein a layer thickness of the adhesive film is in the range from 0.7 mm to 0.9 mm.

20. The laminated pane according to claim 14, wherein the barrier film comprises at least one of: a) a coating, b) a colorant, and c) a printing.

21. The laminated pane according to claim 20, wherein the coating is implemented as a barrier coating.

22. The laminated pane according to claim 14, wherein the at least two polymer layers are transparent.

23. The laminated pane according to claim 14,
wherein on a side of the opaque or translucent stone layer facing away from the transparent adhesion-promoting layer, another transparent adhesion-promoting layer is arranged, and
wherein on a side of the transparent adhesion-promoting layer facing away from the opaque or translucent stone layer, another transparent glass pane is arranged.

24. The laminated pane according to claim 14, further comprising a seal arranged on a side of the opaque or translucent stone layer facing away from the transparent adhesion-promoting layer.

25. A method for producing a laminated pane, the method comprising:
(I) adhesively joining an opaque or translucent stone layer to a transparent glass pane via a transparent adhesion-promoting layer; and
(II) sealing a circumferential edge surface with an all-around seal that comprises at least two polymer layers of different materials,
wherein the laminated pane comprises, in order and adhesively joined one atop another,
i) the transparent glass pane,
ii) the transparent adhesion-promoting layer,
iii) the opaque or translucent stone layer, and
iv) the all-around seal.

26. The method according to claim 25, wherein the process steps (I) and (II) are carried out simultaneously with heat treatment.

27. The method according to claim 25, wherein the process step (I) further comprises adhesively joining, a side of the opaque or translucent stone layer facing away from the transparent adhesion-promoting layer, to another transparent glass pane via another transparent adhesion-promoting layer.

28. A method, comprising:
providing a laminated pane according to claim 14; and
using the laminated pane as a purely decorative or decorative architectural component for indoors or outdoors.

29. The method according to claim 28, wherein the purely decorative or decorative architectural component is used as an exterior façade or an interior wall covering.
